(19) United States
(12) Patent Application Publication
(10) Pub. No.: US 2005/0138827 A1
(43) Pub. Date: Jun. 30, 2005

(54) Boston gauge

(76) Inventor: Camie Dennis Gionet, San Jose, CA (US)

Correspondence Address: Camie Dennis Gionet Sr., 95A Cleveland Avenue, San Jose, CA, 95128, US

(21) Appl. No.: 10/749,090

(22) Filed: Dec. 31, 2003

(51) Int. Cl. G01B 5/00

(52) U.S. Cl. 33/542

(57) ABSTRACT

What is new is the interaction of this pivoting finger, to the dial indicator tip, utilizing all the benefits of the dial indicator to make this gauge work, and because the finger tips are 4-48 threaded, it uses all standard dial indicator tips and extensions. For virtually unlimited range.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The field of endeavor to which the invention pertains to is: Measuring instruments used in Machining or the Machinist trade, and in particular, to measuring bores and bore under cuts.

Now, although other tools can be used to measure the same type of diameters, this invention:
1. Uses a large AGD group 2, dial indicator, for easier reading.
2. Has more range of motion than most others.
3. is much easier and faster to set up for use than most others.
4. It needs no stand.
5. It has a greater Range of Diameters than most others that it can measure.
6. It uses all Standard (4-48 threaded extensions and tips), that most machinists already have in their tool boxes'.
7. Is, light weight, compact, corrosion resistant and sturdy.

### BRIEF SUMMARY OF THE INVENTION

This invention will provide a quick, easy, and cheap method of measuring bores, and bore under cuts.

The advantages of the invention are: That it is so quick and easy to get ready for use, and that it is much easier to read the graduations of the large dial indicator used, and also that it can be fitted with all standard, dial indicator, tips and extensions of the 4-48 thread size, for virtually unlimited range.

### BRIEF DESCRIPTION OF THE SEVERAL VIEWS OF THE DRAWING

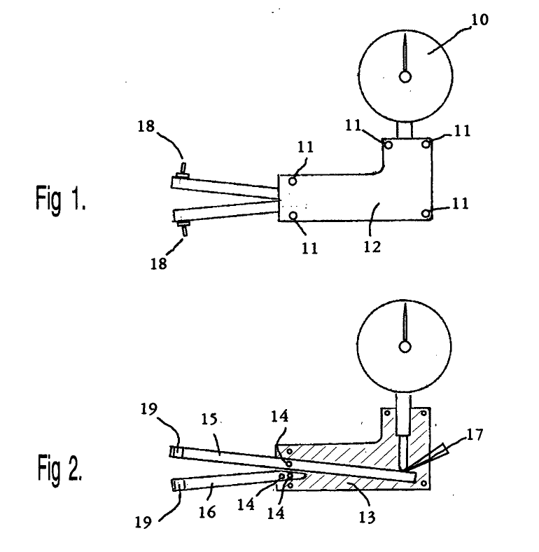

(FIG. 1) is a top view of the preferred embodiment of the invention with a dial indicator mounted thereon for accurately calipering an inside diameter, or bore and or bore under cut.

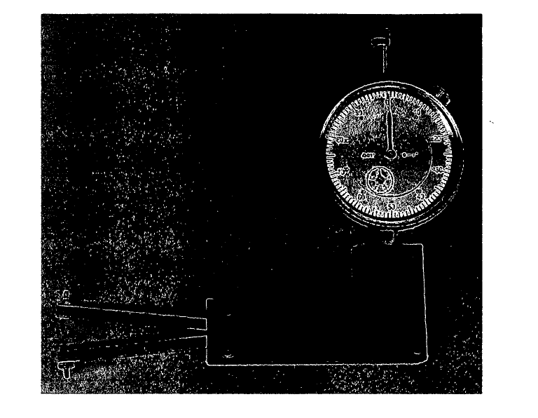

(FIG. 2) is a similar view, with the top body removed to show the internal mechanisms, and how they react and interact.

### DETAILED DESCRIPTION OF THE INVENTION

Boston Gauge: is a precision tool, used to measure internal diameters, and or internal groove diameters, etc. (used primarily in a machine shop).

All parts for this tool will be made using, c.n.c. or manual mills, and or c.n.c. or manual lathes.

To use this gauge, you first screw on any necessary extensions and or tips 18, provided or not, into the 4-48 threaded holes 19. Then using a micrometer or ring gage as a master, simply, insert the fingers 15 and 16 into the micrometer. Then rotate the bezel of the dial indicator 10 to “0”, and clamp it, now, using the comparator principle, size can be determined deviation from “0”. This measurement is carried out by, the interaction of the dial indicator tip and the pivoting finger 15 contact points 17.

This gauge is comprised of:
(1) One “lower body” 13 and one “upper body”12 made from an alloy, or a plastic.
(2) One “fixed finger” 16 and one “pivoting finger”15 made from steel or alloy.
(3) One “dial indicator”10 used to read your measurement from.

The upper 12 and lower 13 bodies, being held together with button head cap screws will hold the dial indicator 10, the pivoting finger 15, and the fixed finger 16, in their proper place. The pivoting finger 15 will pivot on a dowel pin 14, which will be press fit into the lower body 13, and the fixed finger 16 will also be fixed to the lower body 13 and press fit into place with two dowel pins 14.

1. A precision measuring tool, comprising a lower body member carrying a fixed finger, which has a 4-48 threaded hole at the end and is fixed by being press fit by two dowel pins, and a pivoting finger, which also has a 4-48 threaded hole at one end and pivots on a slip fit dowel pin that is press fit into this lower body, and an upper body member, which serves to hold the pivoting finger in its proper place, and to also hold in place a dial indicator which is in constant contact with the pivoting finger and transfers the distance traveled by the pivoting finger tip into a measurement (of the same distance)directly readable on the dial indicator.
